(19) United States
(12) Patent Application Publication
(10) Pub. No.: US 2018/0124425 A1
(43) Pub. Date: May 3, 2018

(54) MOTION ESTIMATION THROUGH MACHINE LEARNING

(71) Applicant: Magic Pony Technology Limited, London (GB)

(72) Inventors: Sebastiaan Van Leuven, London (GB); Jose Caballero, London (GB); Zehan Wang, London (GB); Robert David Bishop, London (GB)

(21) Appl. No.: 15/856,769

(22) Filed: Dec. 28, 2017

Related U.S. Application Data
(63) Continuation of application No. PCT/GB2017/051006, filed on Apr. 11, 2017.

(30) Foreign Application Priority Data
Apr. 11, 2016 (GB) 1606121.0

(51) Int. Cl. H04N 19/53; H04N 19/513; G06T 3/40; H04N 19/159

(52) U.S. Cl. CPC H04N 19/53; H04N 19/159; G06T 3/4046; H04N 19/513

(57) ABSTRACT

Use of machine learning to improve motion estimation in video encoding. According to a first aspect, there is provided a method for estimating the motion between pictures of video data using a hierarchical algorithm, the method comprising steps of: receiving one or more input pictures of video data; identifying, using a hierarchical algorithm, one or more reference elements in one or more reference pictures of video data that are similar to one or more input elements in the one or more input pictures of video data; determining an estimated motion vector relating the identified one or more reference elements to the one or more input elements; and outputting an estimated motion vector.

### CROSS-REFERENCE TO RELATED APPLICATIONS

This application is a continuation of, and claims priority to, International Patent Application No. PCT/GB2017/051006, filed on Apr. 11, 2017, and entitled “MOTION ESTIMATION THROUGH MACHINE LEARNING,” which in turn claims priority to United Kingdom Patent Application No. GB 1606121.0, filed on Apr. 11, 2016, the contents of both of which are incorporated herein by reference in their entireties.

### FIELD

The present disclosure relates to motion estimation in video encoding. For example, the present disclosure relates to the use of machine learning to improve motion estimation in video encoding.

### BACKGROUND

### Video Compression

FIG. 1 illustrates the generic parts of a video encoder. Video compression technologies reduce information in pictures by reducing redundancies available in the video data. This can be achieved by predicting the picture (or parts thereof) from neighbouring data within the same picture (intraprediction) or from data previously signalled in other pictures (interprediction). The interprediction exploits similarities between pictures in a temporal dimension. Examples of such video technologies include, but are not limited to, MPEG2, H.264, HEVC, VP8, VP9, Thor, and Daala. In general, video compression technology comprises the use of different modules. To reduce the data, a residual signal is created based on the predicted samples. Intra-prediction 121 uses previously decoded sample values of neighbouring samples to assist in the prediction of current samples. The residual signal is transformed by a transform module 103 (typically, Discrete Cosine Transform or Fast Fourier Transforms are used). This transformation allows the encoder to remove data in high frequency bands, where humans notice artefacts less easily, through quantisation 105. The resulting data and all syntactical data is entropy encoded 125, which is a lossless data compression step. The quantized data is reconstructed through an inverse quantisation 107 and inverse transformation 109 step. By adding the predicted signal, the input visual data 101 is re-constructed 113. To improve the visual quality, filters, such as a deblocking filter 111 and a sample adaptive offset filter 127 can be used. The reconstructed picture 113 is stored for future reference in a reference picture buffer 115 to allow exploiting the difference static similarities between two pictures. The motion estimation process 117 evaluates one or more candidate blocks by minimizing the distortion compared to the current block. One or more blocks from one or more reference pictures are selected. The displacement between the current and optimal block(s) is used by the motion compensation 119, which creates a prediction for the current block based on the vector. For interpredicted pictures, blocks can be either intra- or interpredicted or both.

Interprediction exploits redundancies between pictures of visual data. Reference pictures are used to reconstruct pictures that are to be displayed, resulting in a reduction in the amount of data required to be transmitted or stored. The reference pictures are generally transmitted before the picture to be displayed. However, the pictures are not required to be transmitted in display order. Therefore, the reference pictures can be prior to or after the current picture in display order, or may even never be shown (i.e., a picture encoded and transmitted for referencing purposes only). Additionally, interprediction allows the use of multiple pictures for a single prediction, where a weighted prediction, such as averaging is used to create a predicted block.

FIG. 2 illustrates a schematic overview of the Motion Compensation (MC) process part of the interprediction. In this process, reference blocks 201 of visual data from reference pictures 203 are combined by means of a weighted average 205 to produce a predicted block of visual data 207. This predicted block 207 of visual data is subtracted from the corresponding input block 209 of visual data in the input picture 211 currently being encoded to produce a residual block 213 of visual data. It is the residual block 213 of visual data, along with the identities of the reference blocks 201 of visual data, which are used by a decoder to reconstruct the encoded block of visual data. In this way the amount of data required to be transmitted to the decoder is reduced.

The closer the predicted block 207 is to the corresponding input block 209 in the picture being encoded 211, the better the compression efficiency will be, as the residual block 213 will not be required to contain as much data. Therefore, matching the predicted block 207 as close as possible to the current input block 209 is essential for good encoding performances. Consequently, finding the optimal reference blocks 201 in the reference pictures 203 is required. However, the process of finding the optimal reference blocks 201, better known as motion estimation, is not defined or specified by a video compression standard.

FIG. 3 illustrates a visualisation of the motion estimation process. An area comprising a number of blocks 301 of a reference picture 303 is searched for a data block 305 that matches the block currently being encoded 307 most closely, and a motion vector 309 can be determined that relates the position of this reference block 305 to the block currently being encoded 307. The motion estimation will evaluate a number of blocks in the reference picture 301. By applying a translation between the picture currently being encoded 311 and the reference picture 303, any candidate block in the reference picture can be evaluated. In principle, any block of pixels in the reference picture 303 can be evaluated to find the optimal reference block 305. However, this may be computationally expensive, and some implementations optimise this search by limiting the number of blocks to be evaluated from the reference picture 303. Therefore, the optimal reference block 305 might not be found.

When the optimal block 305 is found, the motion compensation creates the residual block, which is used for transformation and quantisation. The difference in position between the current block 307 and the optimal block 305 in the reference picture 303 is signalled in the form of a motion vector 309, which also indicates the identity of the reference picture 303 being used as a reference.

Motion estimation and compensation are part of video encoding. In order to encode a single picture, a motion field has to be estimated that will describe the displacement undergone by the spatial content of that picture relative to one or more reference pictures. Ideally, this motion field would be dense, such that each pixel in the picture has an individual correspondence in the one or more reference pictures. The encoding of dense motion fields is usually referred to as optical flow, and different methods have been suggested to estimate it. However, obtaining accurate pixelwise motion fields may be computationally challenging and expensive, hence in practice encoders resort to block matching algorithms that look for correspondences for blocks of pixels instead. This, in turn, can limit the compression performance of the encoder.

### Machine Learning Techniques

Machine learning is the field of study where a computer or computers learn to perform classes of tasks using the feedback generated from the experience or data gathered that the machine learning process acquires during computer performance of those tasks.

Typically, machine learning can be broadly classed as supervised and unsupervised approaches, although there are particular approaches such as reinforcement learning and semi-supervised learning which have special rules, techniques and/or approaches.

Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets.

Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled.

For unsupervised machine learning, there is a range of possible applications such as, for example, the application of computer vision techniques to image processing or video enhancement. Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships.

When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training, and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

### SUMMARY

Aspects and/or embodiments are set out in the appended claims.

Some aspects and/or embodiments seek to provide a method for motion estimation in video encoding that utilises hierarchical algorithms to improve the motion estimation process.

According to a first aspect, there is provided a method for estimating the motion between pictures of video data using a hierarchical algorithm, the method comprising steps of: receiving one or more input pictures of video data; identifying, using a hierarchical algorithm, one or more reference elements in one or more reference pictures of video data that are similar to one or more input elements in the one or more input pictures of video data; determining an estimated motion vector relating the identified one or more reference elements to the one or more input elements; and outputting an estimated motion vector.

In an embodiment, the use of a hierarchical algorithm to search a reference picture to identify elements similar to those of an input picture and determine the estimated motion vector can provide an enhanced method of motion estimation that can return an accurate estimated motion vector without the need for block-by-block searching of the reference picture. Returning an accurate estimated motion estimation vector can reduce the size of the residual block required in the motion compensation process, allowing it to be calculated and transmitted more efficiently.

In some implementations, the hierarchical algorithm is one of: a nonlinear hierarchical algorithm; a neural network; a convolutional neural network; a recurrent neural network; a long short-term memory network; a 3D convolutional network; a memory network; or a gated recurrent network.

The use of any of a non-linear hierarchical algorithm; neural network; convolutional neural network; recurrent neural network; long short-term memory network; 3D convolutional network; a memory network; or a gated recurrent network allows a flexible approach when determining the estimated motion vector. The use of an algorithm with a memory unit such as a long short-term memory network (LSTM), a memory network or a gated recurrent network can keep the state of the motion fields from previous frames to update the motion fields with a new frame each time, rather than needing to apply the hierarchical algorithm to multiple frames with at least one frame being the previous frame. The use of these networks can improve computational efficiency and also improve temporal consistency in the motion estimation across a number of frames, as the algorithm maintains some sort of state or memory of the changes in motion. This can additionally result in a reduction of error rates.

In some implementations, the hierarchical algorithm comprises one or more dense layers.

The use of dense layers within the hierarchical algorithm allows global spatial information to be used when determining the estimated motion vector, allowing a greater range of possible blocks or pixels in the reference picture or picture to be considered.

In some implementations, the step of identifying the one or more reference elements in the one or more reference pictures comprises performing one or more convolutions on local sections of the one or more input pictures of video data.

Using convolutions allows the hierarchical algorithm to focus on spatiotemporal redundancies found in local sections of the input pictures

In some implementations, the step of identifying the one or more reference elements in the one or more reference pictures comprises performing one or more strided convolutions on the one or more input pictures of video data.

Using strided convolutions allows for the capture large motion displacements.

In some implementations, the hierarchical algorithm has been developed using a learned approach.

In some implementations, the learned approach comprises training the hierarchical algorithm on one or more pairs of known reference pictures.

In some implementations, the one or more pairs of known reference pictures are related by a known motion vector.

By training the hierarchical algorithm on sets of reference pictures related by a known motion vector, the hierarchical algorithm can be substantially optimised for the motion estimation process.

In some implementations, the similarity of the one or more reference elements to the one or more original elements is determined using a metric.

In some implementations, the metric comprises at least one of: a subjective metric; a sum of absolute differences; or a sum of squared errors.

In some implementations, the metric is selected from a plurality of metrics based on properties of the input picture.

The use of different metrics to determine the similarity of elements in the input picture to elements in the reference picture allows for a flexible approach to determining element similarity, which can depend on the type of video data being processed.

In some implementations, the estimated motion vector describes a dense motion field.

Dense motion fields map pixels in a reference picture to pixels in the input picture, allowing an accurate representation of the input picture to be constructed, and consequently requiring a smaller residual to be needed in a motion compensation process.

In some implementations, the estimated motion vector describes a block wise displacement field.

Blockwise displacement fields map blocks of visual data in a reference picture to blocks of visual data in an input picture. Matching blocks of visual data in an input picture to those in a reference picture can reduce the computational effort required in comparison to matching individual pixels.

In some implementations, the block wise displacement field relates reference blocks of visual data in the reference picture of video data to input blocks of data in the input picture by at least one of: a translation; an affine transformation; or a warping.

In some implementations, the estimated motion vector describes a plurality of possible block wise displacement fields.

By providing a plurality of possible block wise displacement fields during the motion estimation process, the choice of an optimum motion vector can be delayed until after further processing, for example during a second (refinement) phase of the motion estimation process. Knowledge of the possible residual blocks can potentially be used in the motion estimation process to determine which of the possibilities is the optimal one.

In some implementations, the one or more reference pictures of video data comprises a plurality of reference pictures of video data.

By searching multiple reference pictures for similar elements in parallel, or by exploiting known similarities between the reference pictures, the efficiency of the method can be enhanced.

In some implementations, the plurality of reference pictures of video data comprises two or more reference pictures at different resolutions.

Searching multiple copies of a reference picture, each at different resolutions, allows for reference elements that are similar to the input elements to be searched in parallel in multiple spatial scales, which can enhance the efficiency of the motion estimation process.

In some implementations, the one or more input pictures of video data comprises a plurality of input pictures of video data.

Performing the motion estimation process on multiple input pictures of video data substantially in parallel allows redundancies and similarities between the input pictures to be exploited, potentially enhancing the efficiency of the motion estimation process when performing it on sequences of similar input pictures.

In some implementations, the plurality of input pictures of video data comprises two or more input pictures of video data at different resolutions.

Using multiple copies of an input picture, each at different resolutions, allows for reference elements that are similar to the input elements to be searched in parallel in multiple spatial scales, which can enhance the efficiency of the motion estimation process.

In some implementations, the method is performed at a network node within a network.

In some implementations, the method is performed as a step in a video encoding process.

The method can be used to enhance the encoding of a section of video data prior to transmission across a network. By estimating an optimum or close to optimum motion vector, the size of a residual block required to be transmitted across the network can be reduced.

In some implementations, the hierarchical algorithm is content specific.

In some implementations, the hierarchical algorithm is chosen from a library of hierarchical algorithms based on a content type of the one or more pictures of input video data.

Content specific hierarchical algorithms can be trained to specialise in determining an estimated motion vector for particular content types of video data, for example flowing water or moving vehicles, which can increase the speed at which motion vectors are estimated for that particular content type when compared with using a generic hierarchical algorithm.

Herein, the word picture is preferably used to connote an array of picture elements (pixels) representing visual data such as: a picture (for example, an array of luma samples in monochrome format or an array of luma samples and two corresponding arrays of chroma samples in, for example, 4:2:0, 4:2:2, and 4:4:4 colour format); a field or fields (e.g. interlaced representation of a half frame: top-field and/or bottom-field); or frames (e.g. combinations of two or more fields).

### BRIEF DESCRIPTION OF DRAWINGS

Embodiments will now be described, by way of example only and with reference to the accompanying drawings having like-reference numerals, in which:

FIG. 1 illustrates the generic parts of a video encoder;

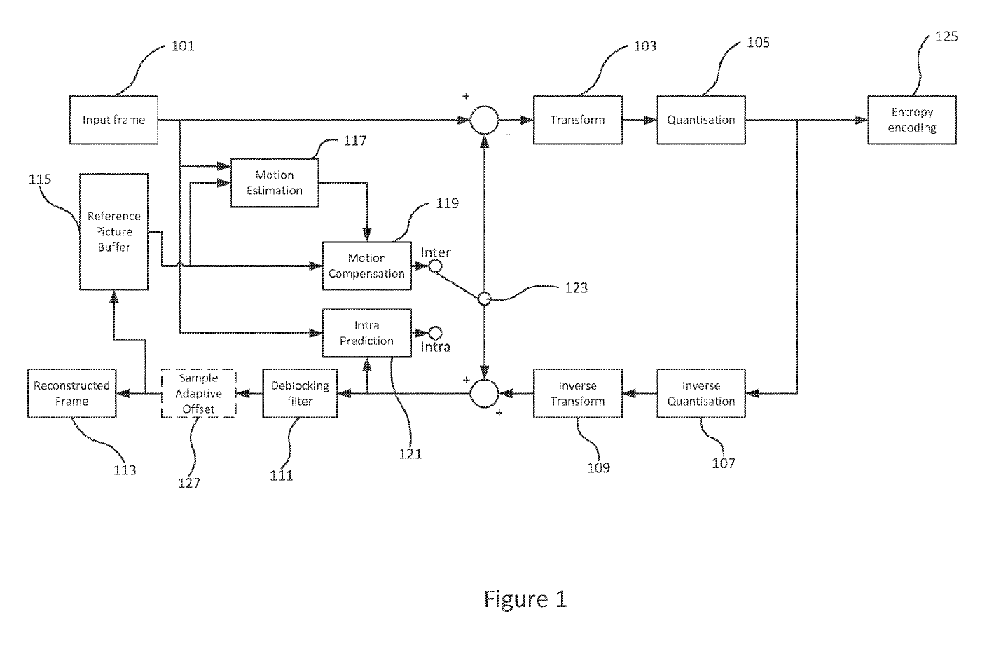

FIG. 2 illustrates a schematic overview of the Motion Compensation (MC) process part of the interprediction;

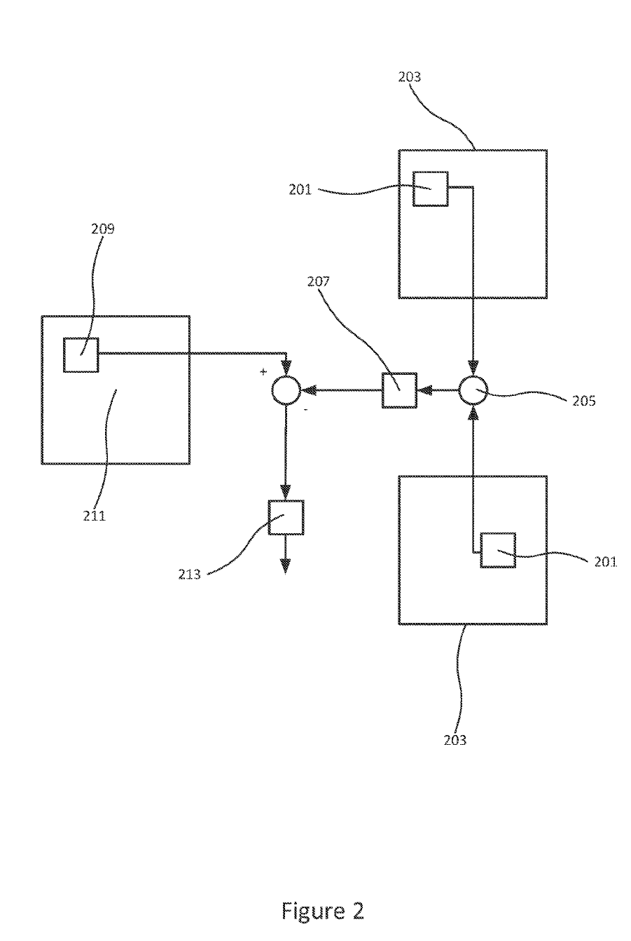

FIG. 3 illustrates a visualisation of the motion estimation process;

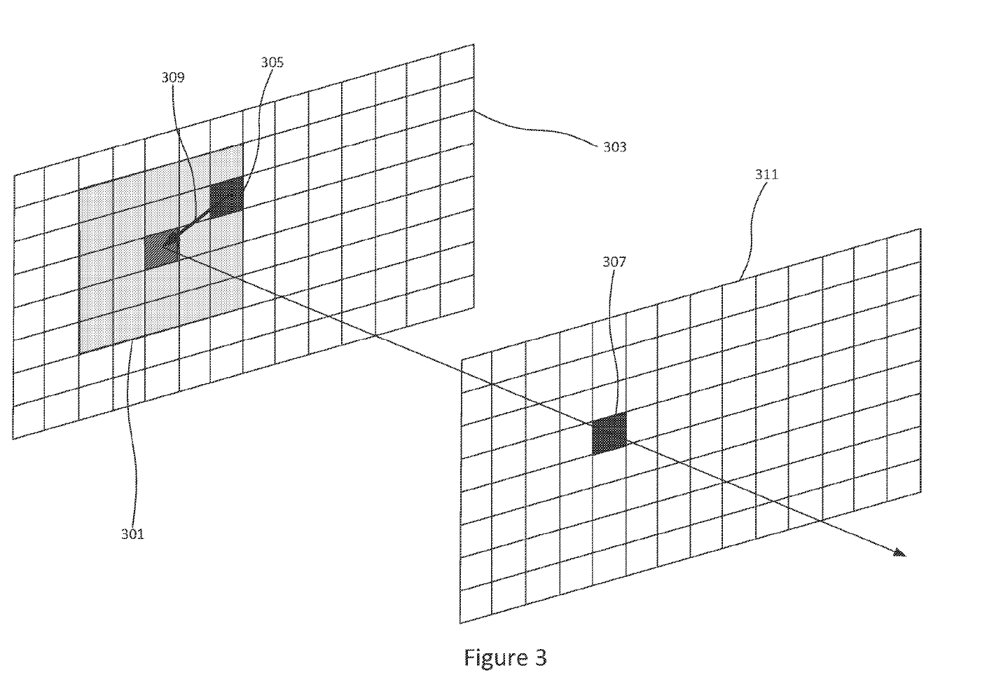

FIG. 4 illustrates an embodiment of the motion estimation process;

FIG. 5 illustrates a further embodiment of the motion estimation process; and

FIG. 6 illustrates an apparatus comprising a processing apparatus and memory according to an exemplary embodiment.

### DETAILED DESCRIPTION

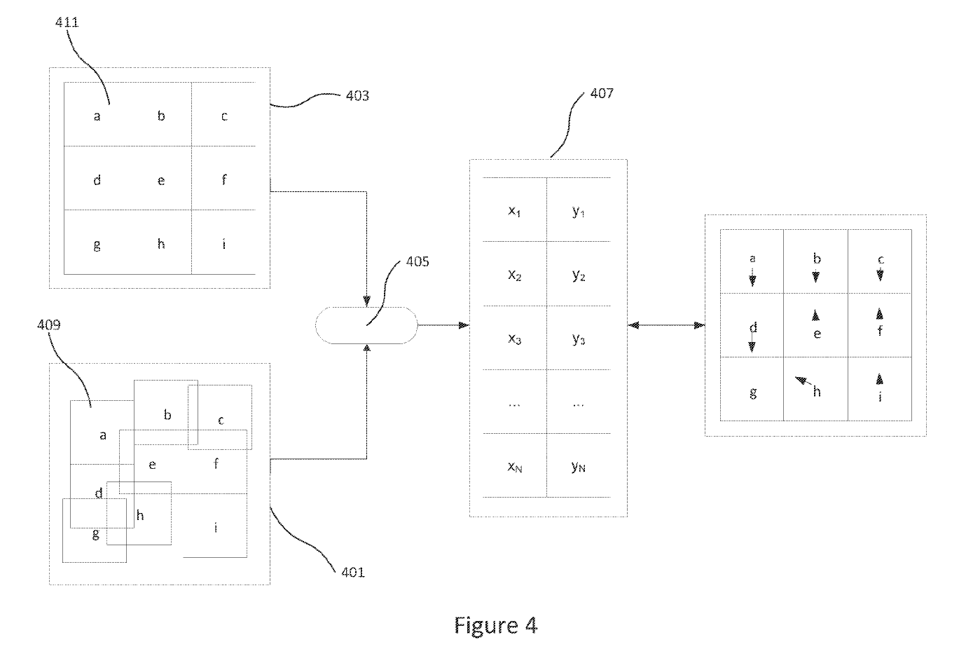

Referring to FIGS. 4 to 6, exemplary embodiments of motion estimation processes will now be described.

FIG. 4 illustrates an embodiment of the motion estimation process. The method can optimize the motion estimation process through machine learning techniques. The input is the current picture 401 and one or more reference pictures 403 stored in a reference buffer. The output of the algorithm 405 is the applicable reference picture 403 and one or more estimated motion vectors 407 that can be used to identify the optimal position in the reference picture 403 to use as prediction for each element (such as a block or pixel) of the current pictures 401.

The algorithm 405 is a hierarchical algorithm, such as a non-linear hierarchical algorithm, neural network, convolutional neural network, recurrent neural network, long short-term memory network, 3D convolutional network, a memory network or a gated recurrent network, which is pre-trained on visual data prior to the encoding process. Pairs of training pictures, one a reference picture and one an example of an input picture (which may itself be another reference picture), either with a known motion field between them or without, are used to train the algorithm using machine learning techniques, which is then stored in a library of trained algorithms.

Different algorithms can be trained on pairs of training pictures containing different content to populate the library with content specific algorithms. The content types can be, for example, the subject of the visual data in the pictures or the resolution of the pictures. These algorithms can be stored in the library with metric data relating to the content type on which they have been trained.

The input of the motion estimation (ME) process is a number of pixels, corresponding with an area 409 of the original current picture 401, and one or more reference pictures 403 previously transmitted, which are decoded and stored in a buffer (or memory). The goal of the ME process is to find a part 411 of the buffered reference picture 403 that has the highest resemblance to the area 409 of the original picture 401. The identified part 411 of the reference picture can have subpixel accuracy, i.e., positions in between pixels can be used for prediction by interpolating those values from neighbouring pixels. The more the current picture 401 and reference picture 411 are similar, the less data the residual block will have, and the better the compression efficiency. Therefore, the optimal position is found by evaluating all blocks (or individual pixels) and using the block (or pixel) which minimizes the difference between the current block (or pixel) and a position within the reference picture. Any metric can be used such as Sum of Absolute Differences (SAD), Sum of Squared Errors (SSE), or a subjective metric. In some embodiments, the type of metric to be used can be determined by the content of the input picture, and can be selected from a set of more than one possible metric.

In the embodiment shown, the input to the processing module is a single current picture 401 to be encoded and a single reference picture 403.

Alternatively, the input could be the single picture to be encoded and multiple reference pictures. By providing more than one reference picture the capabilities of the motion estimation can be enhanced, since the space explored when looking for suitable displacement matches would be larger.

Similarly, more than one single picture to encode could be input, allowing for multiple pictures to be encoded jointly. For pictures that share similar motion displacements, such a sequence of similar pictures in a scene of a video, this can improve the overall efficiency of the picture encoding.

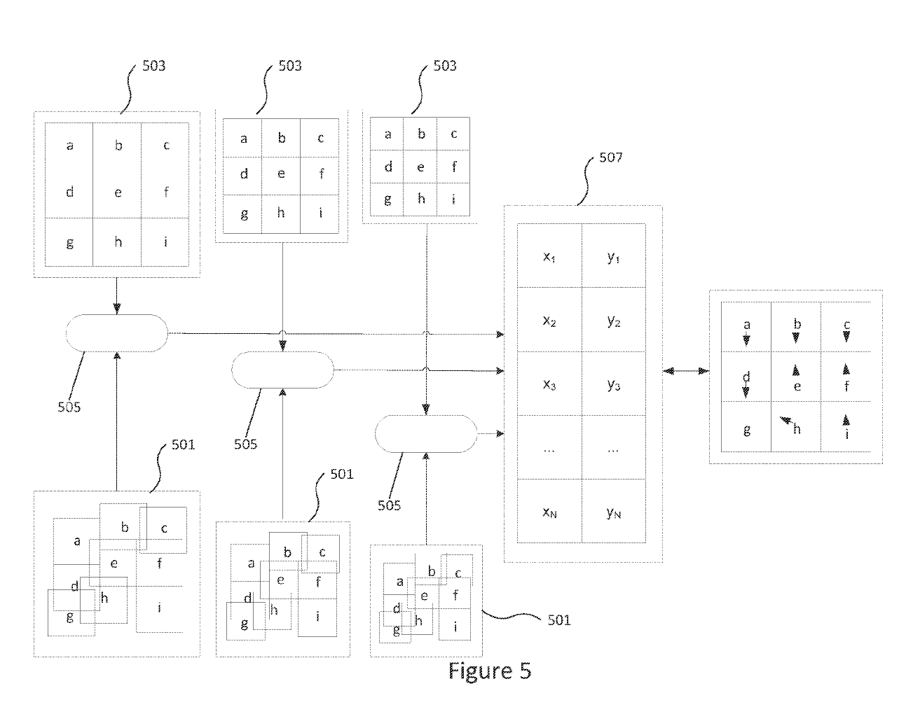

FIG. 5 illustrates a further embodiment, in which the input is multiple original pictures 501 at different resolutions that are derived from a single original picture, and multiple reference pictures 503 at different resolutions that are derived from a single reference picture. In doing so, the receptive field searched by processing module can be expanded. Each pair of pictures, one original picture and one reference picture at the same resolution, can be input into a separate hierarchical algorithm 505 in order to search for an optimal block. Alternatively, the pictures at different resolutions can be input into a single hierarchical algorithm. The output of the hierarchical algorithms is one or more estimated motion vectors 507 that can be used to identify the optimal position in the reference pictures 503 to use as prediction for each block of the current pictures 501.

Based on the content type of the input picture, which can be determined from metric data associated with that input picture, a pre-trained, content specific hierarchical algorithm can be selected from a library of hierarchical algorithms to perform the motion estimation process. If no suitable content specific hierarchical algorithm is available, or if no library is present, then a generic pre-trained hierarchical algorithm can be used instead.

The modelling used to map motion in the input picture relative to the reference picture is a network that processes the input pictures in a hierarchical fashion through a concatenation of layers, using, for example, a neural network, a convolutional neural network or a non-linear hierarchical algorithm. The parameters defining the operations of these layers are trainable and are optimised from prior examples of pairs of reference pictures and the known optimal displacement vectors that relate them to each other. In its most simple form, a succession of layers is used where each focuses on the representation of spatiotemporal redundancies found in predefined local sections of the input pictures. This can be performed as a series of convolutions with pre-trained filters on the input picture.

A variation of these layers can be introducing at least one dense processing layer, where representations of the pictures are obtained from global spatial information rather than local sections.

Another possibility is to use strided convolutions, where additional tracks that perform convolutions on spatially strided spaces of the input pictures are incorporated in addition to the single processing track that operates on all local regions of the picture. This idea shares the notion of multiresolution processing and would capture large motion displacements, which might otherwise be difficult to capture at full picture resolution but could be found if the picture is subsampled to lower resolutions.

Moreover, the input to the motion estimation module does not need to be limited to pixel intensity information. Likewise, the learning process could also exploit higher level descriptions of the reference and target pictures, such as saliency maps, wavelet or histogram of gradients features, or metadata describing the video content.

A further alternative is to rely on spatially transforming layers. Given a set of control points in current pictures and reference pictures, these will produce the spatial transformation undergone by those particular points. These networks have been originally proposed for an improved image classification, because registering images to a common space greatly reduces the variability among images that belong to the same class. However, they can very efficiently encode motion, given that the displacement vectors necessary for an accurate image registration can be interpreted as motion fields.

The minimal expression of the output of the motion estimation module is a single vector describing the X and Y coordinate displacement for spatial content in the input picture relative to the reference picture. This vector could describe either a dense motion field, where each pixel in the input picture would be assigned a displacement, or a blockwise displacement similar to a blockmatching operation, where each block of visual data in the input picture is assigned a displacement. Alternatively, the output of the model could provide augmented displacement vectors, where multiple displacement possibilities are assigned to each pixel or block of data. Further processing could then either choose one of these displacements or produce a refined one based on some predefined mixing criteria.

In some embodiments, the displacement of the input block relative to the reference block is not just a translation, but can be any of an affine transformation; a style transfer; or a warping. This allows for the reference block to be related to the input block by rotation, scaling and/or other transformations in addition to a translation.

The proposed method for motion estimation could be used in different ways to improve the quality of a video encoder. In the most trivial form, the proposed method could be used to directly replace current block matching algorithms that are used to find picture correspondences. The estimation of dense motion fields have the potential to outperform blockmatching algorithms given that they provide pixelwise accuracy, and the trainable module would be data adaptive and could be tuned to motion found in a particular media content. Likewise, the motion field estimated could also be used as an additional input to a blockmatching algorithm to guide the search operation. This can potentially improve their efficiency by reducing the search space they need to explore or as augmented information to improve their accuracy.

The above described methods can be implemented at a node within a network, such as a content server containing video data, as part of the video encoding process prior to transmission of the video data across the network.

Any system feature as described herein may also be provided as a method feature, and vice versa. As used herein, means plus function features may be expressed alternatively in terms of their corresponding structure.

Any feature in some aspects may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

Particular combinations of the various features described and defined in any aspects can be implemented and/or supplied and/or used independently.

Some of the example embodiments are described as processes or methods depicted as diagrams. Although the diagrams describe the operations as sequential processes, operations may be performed in parallel, or concurrently or simultaneously. In addition, the order or operations may be re-arranged. The processes may be terminated when their operations are completed, but may also have additional steps not included in the figures. The processes may correspond to methods, functions, procedures, subroutines, subprograms, etc.

Methods discussed above, some of which are illustrated by the diagrams, may be implemented by hardware, software, firmware, middleware, microcode, hardware description languages, or any combination thereof. When implemented in software, firmware, middleware or microcode, the program code or code segments to perform the relevant tasks may be stored in a machine or computer readable medium such as a storage medium. A processing apparatus may perform the relevant tasks.

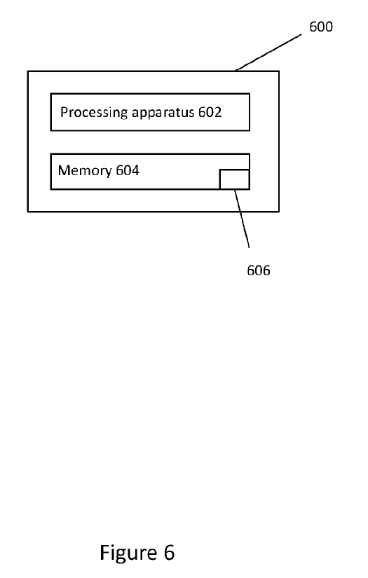

FIG. 6 shows an apparatus 600 comprising a processing apparatus 602 and memory 604 according to an exemplary embodiment. Computer-readable code 606 may be stored on the memory 604 and may, when executed by the processing apparatus 602, cause the apparatus 600 to perform methods as described here, for example a method with reference to FIGS. 4 and 5.

The processing apparatus 602 may be of any suitable composition and may include one or more processors of any suitable type or suitable combination of types. Indeed, the term “processing apparatus” should be understood to encompass computers having differing architectures such as single/multi-processor architectures and sequencers/parallel architectures. For example, the processing apparatus may be a programmable processor that interprets computer program instructions and processes data. The processing apparatus may include plural programmable processors. Alternatively, the processing apparatus may be, for example, programmable hardware with embedded firmware. The processing apparatus may alternatively or additionally include Graphics Processing Units (GPUs), or one or more specialised circuits such as field programmable gate arrays FPGA, Application Specific Integrated Circuits (ASICs), signal processing devices etc. In some instances, processing apparatus may be referred to as computing apparatus or processing means.

The processing apparatus 602 is coupled to the memory 604 and is operable to read/write data to/from the memory 604. The memory 604 may comprise a single memory unit or a plurality of memory units, upon which the computer readable instructions (or code) is stored. For example, the memory may comprise both volatile memory and non-volatile memory. In such examples, the computer readable instructions/program code may be stored in the non-volatile memory and may be executed by the processing apparatus using the volatile memory for temporary storage of data or data and instructions. Examples of volatile memory include RAM, DRAM, and SDRAM etc. Examples of non-volatile memory include ROM, PROM, EEPROM, flash memory, optical storage, magnetic storage, etc.

An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Methods described in the illustrative embodiments may be implemented as program modules or functional processes including routines, programs, objects, components, data structures, etc., that perform particular tasks or implement particular functionality, and may be implemented using existing hardware. Such existing hardware may include one or more processors (e.g. one or more central processing units), digital signal processors (DSPs), application-specific-integrated-circuits, field programmable gate arrays (FPGAs), computers, or the like.

Unless specifically stated otherwise, or as is apparent from the discussion, terms such as processing or computing or calculating or determining or the like, refer to the actions and processes of a computer system, or similar electronic computing device. Note also that software implemented aspects of the example embodiments may be encoded on some form of non-transitory program storage medium or implemented over some type of transmission medium. The program storage medium may be magnetic (e.g. a floppy disk or a hard drive) or optical (e.g. a compact disk read only memory, or CD ROM), and may be read only or random access. Similarly the transmission medium may be twisted wire pair, coaxial cable, optical fibre, or other suitable transmission medium known in the art. The example embodiments are not limited by these aspects in any given implementation.

Further implementations are summarized in the following examples:

### Example 1

A method for estimating the motion between pictures of video data using a hierarchical algorithm, the method comprising steps of:

receiving one or more input pictures of video data;

identifying, using a hierarchical algorithm, one or more reference elements in one or more reference pictures of video data that are similar to one or more input elements in the one or more input pictures of video data;

determining an estimated motion vector relating the identified one or more reference elements to the one or more input elements; and

outputting an estimated motion vector.

### Example 2

A method according to example 1, wherein the hierarchical algorithm is one of: a nonlinear hierarchical algorithm; a neural network; a convolutional neural network; a recurrent neural network; a long short-term memory network; 3D convolutional network; a memory network; or a gated recurrent network.

### Example 3

A method according to example 2, wherein the hierarchical algorithm comprises one or more dense layers.

### Example 4

A method according to any preceding example, wherein the step of identifying the one or more reference elements in the one or more reference pictures comprises performing one or more convolutions on local sections of the one or more input pictures of video data.

### Example 5

A method according to any preceding example, wherein the step of identifying the one or more reference elements in the one or more reference pictures comprises performing one or more strided convolutions on the one or more input pictures of video data.

### Example 6

A method according to any preceding example, wherein the hierarchical algorithm has been developed using a learned approach.

### Example 7

A method according to example 6, wherein the learned approach comprises training the hierarchical algorithm on one or more pairs of known reference pictures.

### Example 8

A method according to example 7, wherein the one or more pairs of known reference pictures are related by a known motion vector.

### Example 9

A method according to any preceding example, wherein the similarity of the one or more reference elements to the one or more original elements is determined using a metric.

### Example 10

A method according to example 9, wherein the metric comprises at least one of: a subjective metric; a sum of squared difference; or a sum of squared errors.

### Example 11

A method according to examples 9 or 10, wherein the metric is selected from a plurality of metrics based on properties of the input picture.

### Example 12

A method according to any preceding example, wherein the estimated motion vector describes a dense motion field.

### Example 13

A method according to any of examples 1 to 11, wherein the estimated motion vector describes a block wise displacement field.

### Example 14

A method according to example 13, wherein the block wise displacement field relates reference blocks of visual data in the reference picture of video data to input blocks of data in the input picture of video data by at least one of: a translation; an affine transformation; a style transfer; or a warping.

### Example 15

A method according to examples 13 or 14, wherein the estimated motion vector describes a plurality of possible block wise displacement fields.

### Example 16

A method according to any preceding example, wherein the one or more reference pictures of video data comprises a plurality of reference pictures of video data.

### Example 17

A method according to example 16, wherein the plurality of reference pictures of video data comprises two or more reference pictures at different resolutions.

### Example 18

A method according to any preceding example, wherein the one or more input pictures of video data comprises a plurality of input pictures of video data.

### Example 19

A method according to example 18, wherein the plurality of input pictures of video data comprises two or more input pictures of video data at different resolutions.

### Example 20

A method according to any preceding example, wherein the method is performed at a network node within a network.

### Example 21

The method of any preceding example, wherein the method is performed as a step in a video encoding process.

### Example 22

A method according to any preceding example, wherein the hierarchical algorithm is content specific.

### Example 23

A method according to any preceding example, wherein the hierarchical algorithm is chosen from a library of hierarchical algorithms based on a content type of the one or more input pictures of video data.

### Example 24

A method substantially as hereinbefore described in relation to FIGS. 4 to 5.

### Example 25

Apparatus comprising:

at least one processor;

at least one memory including computer program code which, when executed by the at least one processor, causes the apparatus to perform the method of any one examples 1 to 24.

### Example 26

A computer readable medium having computer readable code stored thereon, the computer readable code, when executed by at least one processor, causing the performance of the method of any one of examples 1 to 24.

What is claimed is:

1. A method for estimating the motion between pictures of video data using a hierarchical algorithm, the method comprising steps of:
receiving one or more input pictures of video data;
identifying, using a hierarchical algorithm, one or more reference elements in one or more reference pictures of video data that are similar to one or more input elements in the one or more input pictures of video data;
determining an estimated motion vector relating the identified one or more reference elements to the one or more input elements; and
outputting an estimated motion vector.

2. The method according to claim 1, wherein the hierarchical algorithm is one of: a nonlinear hierarchical algorithm; a neural network; a convolutional neural network; a recurrent neural network; a long short-term memory network; 3D convolutional network; a memory network; or a gated recurrent network.

3. The method according to claim 2, wherein the hierarchical algorithm comprises one or more dense layers.

4. The method according to claim 1, wherein the step of identifying the one or more reference elements in the one or more reference pictures comprises performing one or more convolutions on local sections of the one or more input pictures of video data.

5. The method according to claim 1, wherein the step of identifying the one or more reference elements in the one or more reference pictures comprises performing one or more strided convolutions on the one or more input pictures of video data.

6. The method according to claim 1, wherein the hierarchical algorithm has been developed using a learned approach.

7. The method according to claim 6, wherein the learned approach comprises training the hierarchical algorithm on one or more pairs of known reference pictures.

8. The method according to claim 7, wherein the one or more pairs of known reference pictures are related by a known motion vector.

9. The method according to claim 1, wherein the similarity of the one or more reference elements to the one or more original elements is determined using a metric.

10. The method according to claim 9, wherein the metric comprises at least one of: a subjective metric; a sum of squared difference; or a sum of squared errors.

11. The method according to claim 9, wherein the metric is selected from a plurality of metrics based on properties of the input picture.

12. The method according to claim 1, wherein the estimated motion vector describes a dense motion field.

13. The method according to claim 1, wherein the estimated motion vector describes a block wise displacement field.

14. The method according to claim 13, wherein the block wise displacement field relates reference blocks of visual data in the reference picture of video data to input blocks of data in the input picture of video data by at least one of: a translation; an affine transformation; a style transfer; or a warping.

15. The method according to claim 13, wherein the estimated motion vector describes a plurality of possible block wise displacement fields.

16. The method according to claim 1, wherein the one or more reference pictures of video data comprises a plurality of reference pictures of video data.

17. The method according to claim 16, wherein the plurality of reference pictures of video data comprises two or more reference pictures at different resolutions.

18. The method according to claim 1, wherein the one or more input pictures of video data comprises a plurality of input pictures of video data.

19. Apparatus comprising:
at least one processor;
at least one memory including computer program code which, when executed by the at least one processor, causes the apparatus to perform a method comprising:
receiving one or more input pictures of video data;
identifying, using a hierarchical algorithm, one or more reference elements in one or more reference pictures of video data that are similar to one or more input elements in the one or more input pictures of video data;
determining an estimated motion vector relating the identified one or more reference elements to the one or more input elements; and
outputting an estimated motion vector.

20. A computer readable medium having computer readable code stored thereon, the computer readable code, when executed by at least one processor, causing the performance of a method comprising:
receiving one or more input pictures of video data;
identifying, using a hierarchical algorithm, one or more reference elements in one or more reference pictures of video data that are similar to one or more input elements in the one or more input pictures of video data;
determining an estimated motion vector relating the identified one or more reference elements to the one or more input elements; and
outputting an estimated motion vector.
